(19) United States
(12) Patent Application Publication
(10) Pub. No.: US 2019/0299695 A1
(43) Pub. Date: Oct. 3, 2019

(54) See They ' Self Card

(71) Applicant: Walter Lancaster, Los Angeles, CA (US)

(72) Inventor: Walter Lancaster, Los Angeles, CA (US)

(21) Appl. No.: 16/409,807

(22) Filed: May 11, 2019

Related U.S. Application Data
(63) Continuation-in-part of application No. 29/481,671, filed on Feb. 8, 2014, now abandoned.

(51) Int. Cl. B42D 15/02; B42D 15/04; G09F 1/04

(52) U.S. Cl. CPC B42D 15/027; G09F 1/04; B42D 15/042

(57) ABSTRACT

The completed structures of the “See They’ Self Card's” herein are of Card stock manufactured from any material to include paper, cardboard, and any card stock, and plastics and a highly flexible, highly reflective surface that results with the effect of providing a reflection of the recipient in functioning wherein simultaneously they can See Themselves. To function ?, the present invention requires only an author or drafter for writing or printing upon the Card and an end—user recipient to read the provided scripture and simultaneously See Themselves in the resulting reflection.

### CROSS REFERENCE TO RELATED APPLICATION

This application is a continuation-in-part of the related U.S. patent application Ser. No. 29/481,671 filed Date: Feb. 8, 2014, the contents of which are fully incorporated herein by reference for all purposes in keeping with (37 CFR 1.5).

### FIELD OF INVENTION

This present application of invention of the First Named Inventor “Walter Lancaster” herein “Teaches” of a Card that can become folded with the express intent of said Card being to convey a written or printed or affixed by any means message upon said Card to any end user.

This present application of invention of the First Named Inventor “Walter Lancaster” herein “Teaches” uniquely the hybridization of a Card, with applied upon the Card, a highly flexible, highly reflective surface stock, with the purpose of reflecting the image of the recipient.

### BACKGROUND OF THE INVENTION

Prior art to the present invention is any Card to include a Card that can become folded with the express intent of said Card being to convey a written or printed or affixed by any means message upon this Card to any end user. Prior Art Cards include Cards manufactured from any . . . material to include paper, cardboard and any card stock, and plastics. Furthermore, uniquely herein the present invention is the hybridization of this present invention of a Card with a highly flexible, highly reflective surface stock, with the purpose of reflecting the image of the recipient such as the Prior Art of a Mirror.

The present invention is new, unique and different from all prior art. The present invention is intended to present to the end user recipient with a pre-written message from an end user author or drafter to appear directly aside the installed, applied highly flexible, highly reflective surface stock simultaneously. The present invention now presents a hightened experience by means of written, drafted, or affixed communications fused as hybrid with a highly flexible, highly reflective surface stock resulting in a hightened interactive experience for each and all end-users as with now the ability read of and to See Themselves simultaneously.

The present invention herein combines the industry of Cards in all forms designed to comport any message, any sentiment, or any data and the industry and the manufacture of highly flexible reflective surface stocks that result in the effect of a producing a clear reflection.

### BRIEF SUMMARY OF THE INVENTION

The present application of invention teaches that the Card with a means to comport any message, any sentiment, or any data is now bearing a highly flexible, highly reflective surface that results with the effect of a producing a clear reflection. The present invention includes at least the following basic two components: 1. a Card stock manufactured from any material to include paper, cardboard, and any card stock, and plastics and 2. a highly reflective surface that results with the effect of producing a clear reflection. To function ?, the present invention requires only an author or drafter for message upon the Card and an end-user recipient. The . . . present invention provides a means for comporting a message, sentiment, or data with the express ability for the recipient to See Themselves simultaneously.

The present invention as a Card may become folded, therefore the highly reflective surface applied to this Card herein is one of a stock of material that is highly reflective and highly flexible concurrently.

The present invention as a Card requires only an author, drafter and a recipient to See Themselves to function.

The present invention as a Card is not-complete until affixed to the Card is the required highly flexible, highly reflective surface stock.

### BRIEF DESCRIPTION OF THE DRAWINGS

FIG. 4 is a [01] Upper Front internal view of card in the form and dimension and measurement of a card of greeting with [03] a Highly flexible, highly reflective surface stock cut to measurement applied to card by [02] a Glue adhesive compound applied to the card with a Sample reflected image therein [04].

FIG. 2 is a [01] Upper Front internal view of the card in the form and dimension and measurement of a card that is postal with [03] a Highly flexible, highly reflective surface stock cut to measurement applied by [02] a Glue adhesive compound applied to the card with a Sample reflected image therein [04].

FIG. 3 is a [01] Upper Front internal view of the card in the form and dimension and measurement of a card that is of business with a [03] Highly flexible, highly reflective surface . . . stock cut to measurement with [02] Glue adhesive compound applied to card with a Sample reflected image therein [04].

FIG. 6 FIG. 12 and FIG. 18 present herein the present invention each model card in their full completion.

### DETAILED DESCRIPTION OF THE INVENTION

The first named inventor for the present invention herein tentatively entitled “The See They' Self Card” teaches a Card with a means to comport any message, any sentiment, or any data by writing or print as now a hybrid bearing a highly flexible, highly reflective surface [03] that results with the effect of providing a reflection of the recipient in functioning as a highly reflective surface [04]. The present invention includes at least the following two basic components: 1. a Card stock manufactured from any material to include paper, cardboard, and any card stock, and plastics [01] and 2. a highly reflective surface that results with the effect of providing a clear reflection of the recipient in function [03][04].

The first named inventor for the present invention herein tentatively entitled “The See They' Self Card” teaches a Card requiring only an author or drafter for writing or printing upon the Card [01] and an end-user recipient for the effect of providing a clear reflection of the end-user recipient in function to See Themselves in the resulting reflection upon the Card [04].

The first named inventor for the present invention herein tentatively entitled “The See They' Self Card” teaches a Card providing a means for comporting a message, sentiment, or data [01] with the express ability for the recipient to See Themselves simultaneously upon receiving and reading the authored scripture beside their reflection now upon the Card [FIG. 6] FIG. 12] [FIG. 16].

The first named inventor for the present invention herein tentatively entitled “The See They' Self Card” teaches a Card that may become folded [FIG. 2], therefore the highly flexible, highly reflective surface applied to this Card herein is one of a stock of material that is highly flexible and is highly reflective concurrently [FIG. 5].

The first named inventor for the present invention herein tentatively entitled “The See They' Self Card” teaches a Card requiring only an author, drafter and a recipient to See Themselves to function [FIG. 6] [FIG. 12] [FIG. 16].

The first named inventor for the present invention herein tentatively entitled “The See They' Self Card” teaches a Card that is not-complete until applied to the Card [FIG. 6] [FIG. 12] [FIG. 16] is the required highly flexible, highly reflective surface stock [FIG. 5] [FIG. 11] [FIG. 17].

### FIGURE DESCRIPTIONS

### FIG. 1 of 18

[01] Upper Rear view of card in the form and dimension and measurement of a card of greeting

### FIG. 2 of 18

[01] Upper Side view of card in the form and dimension and measurement of a card of greeting

### FIG. 3 of 18

[01] Upper Front internal view of card in the form and dimension and measurement of a card of greeting

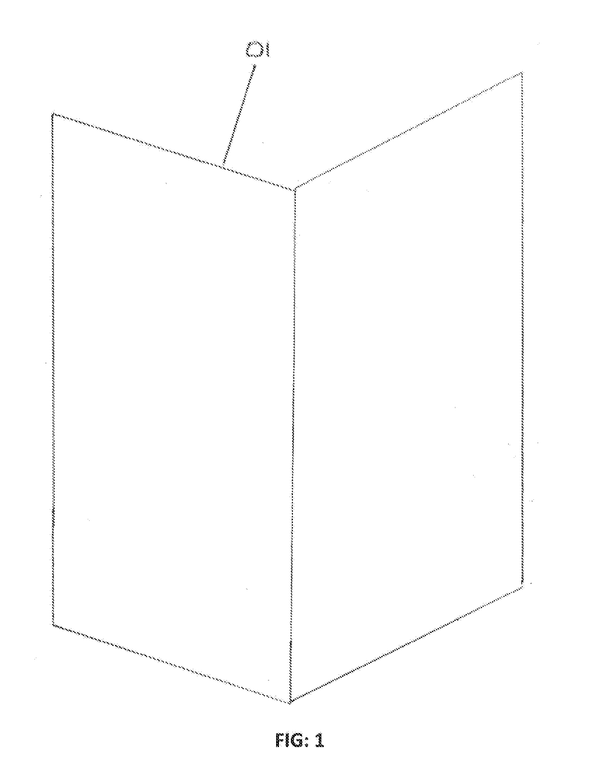

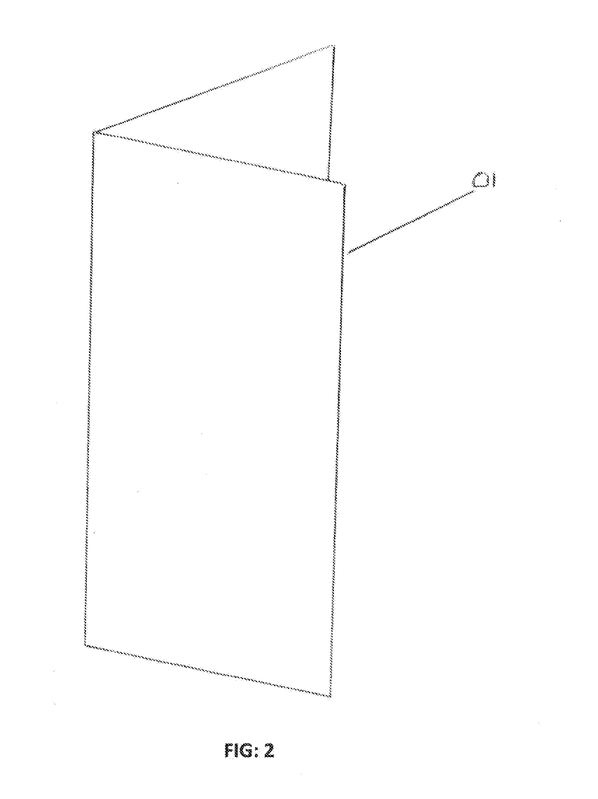

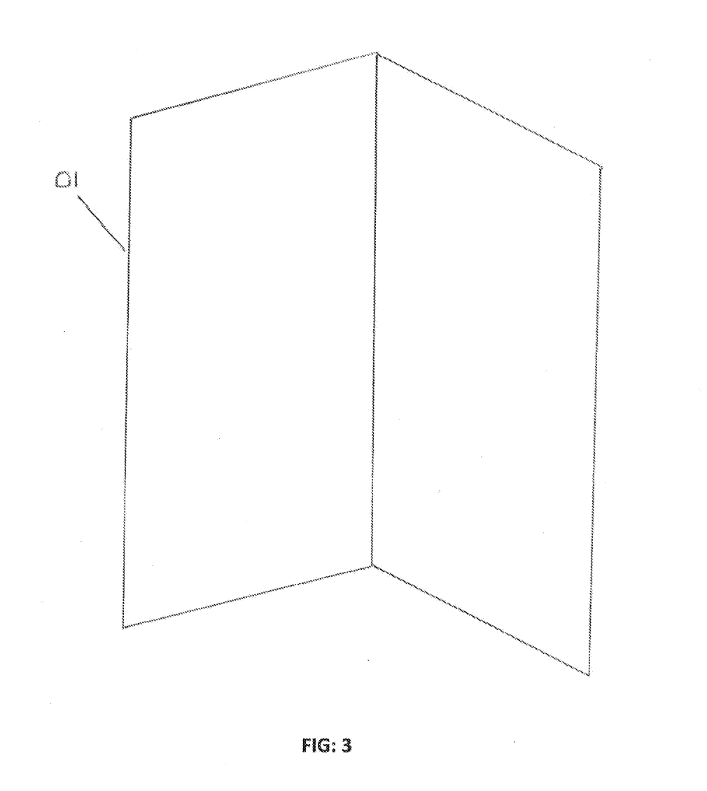

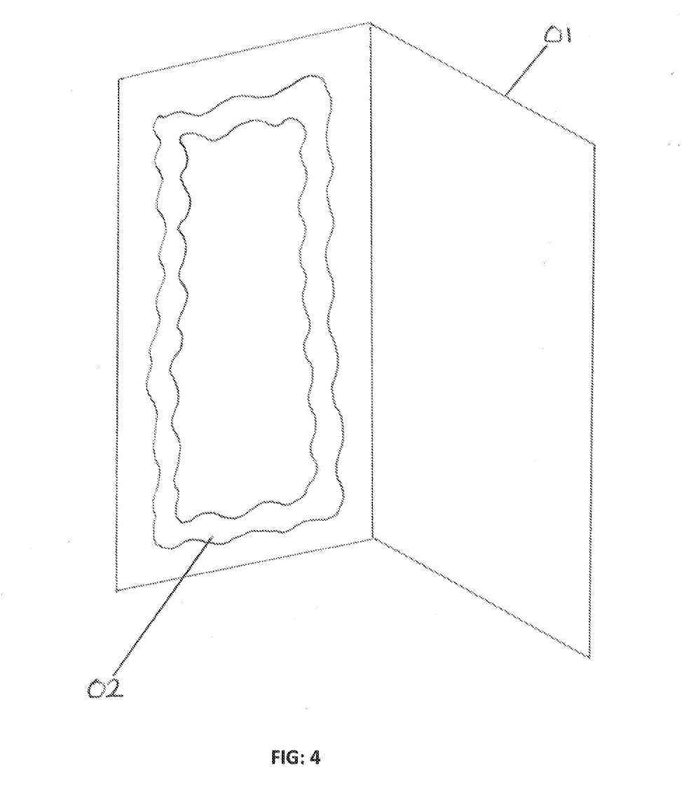

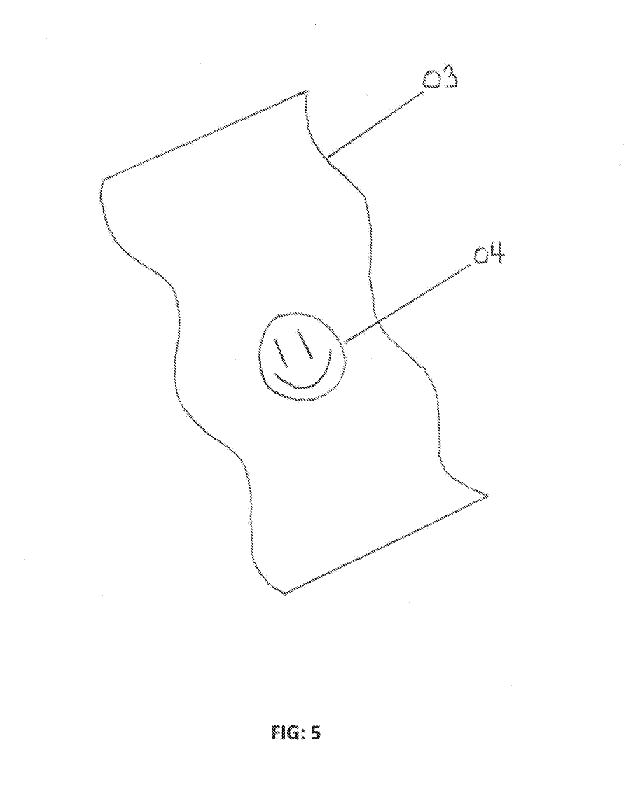

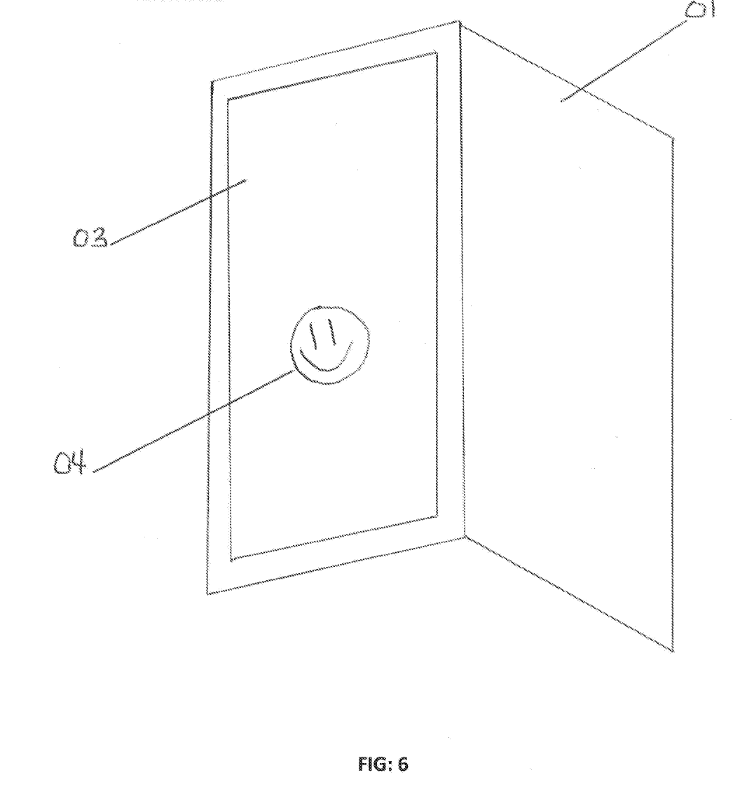

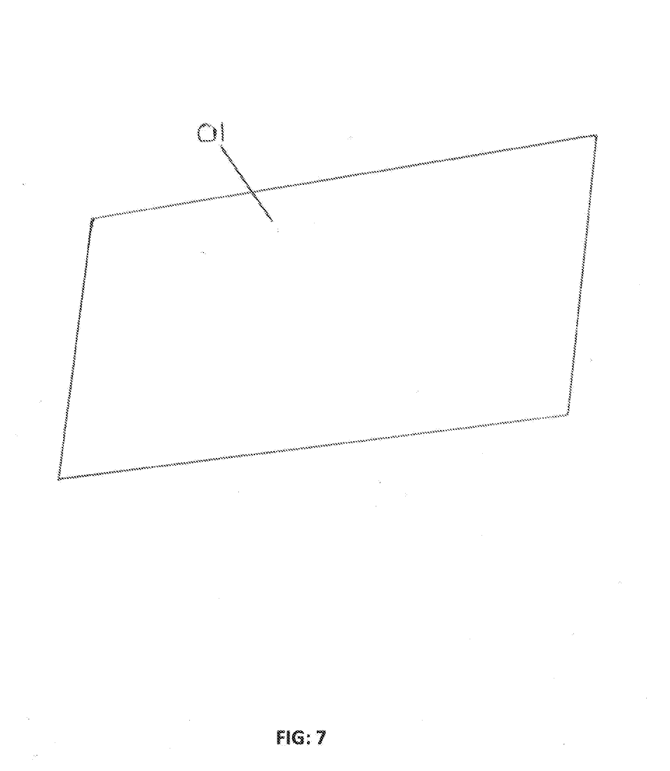

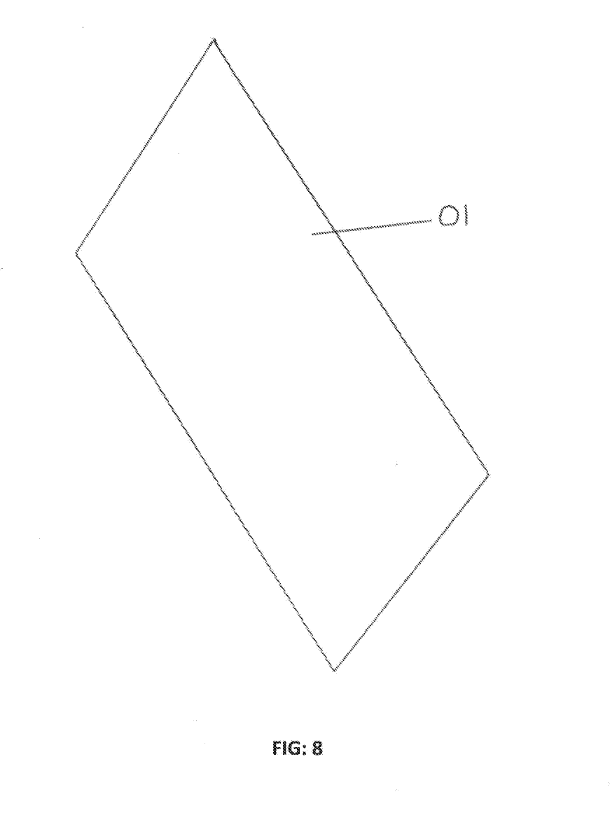

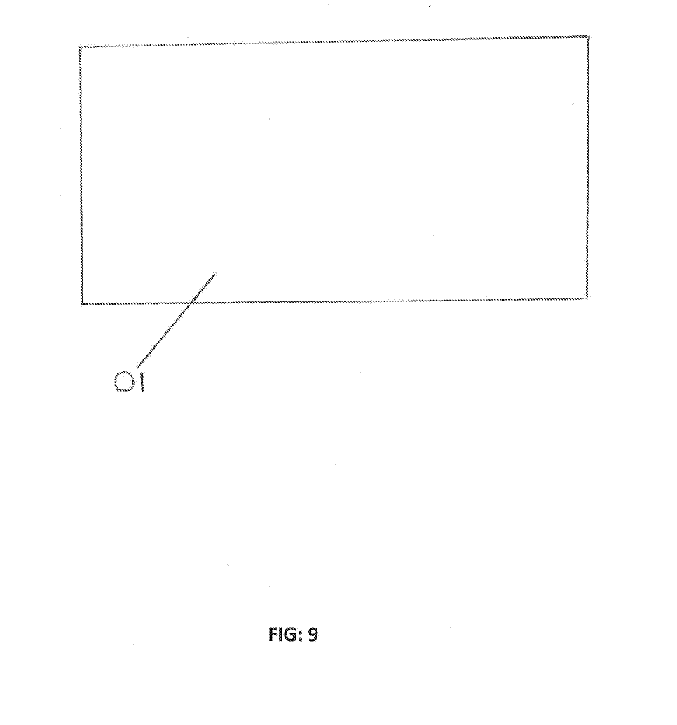

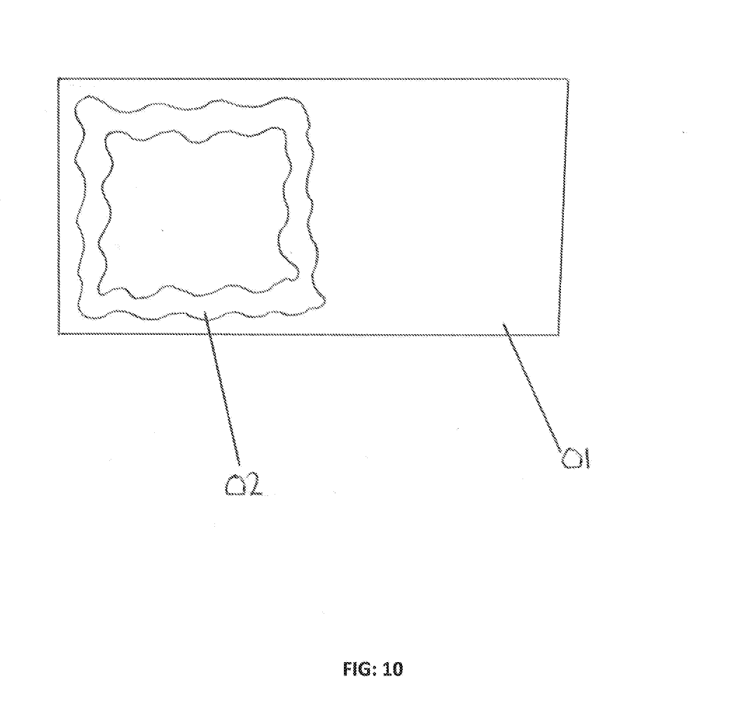

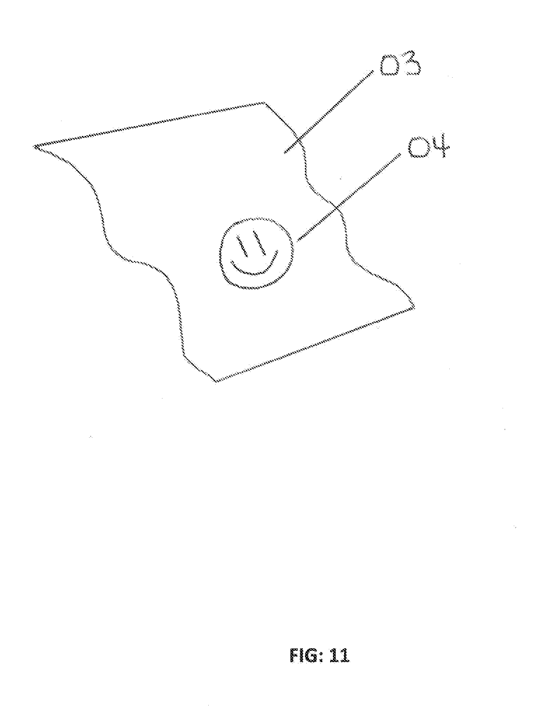

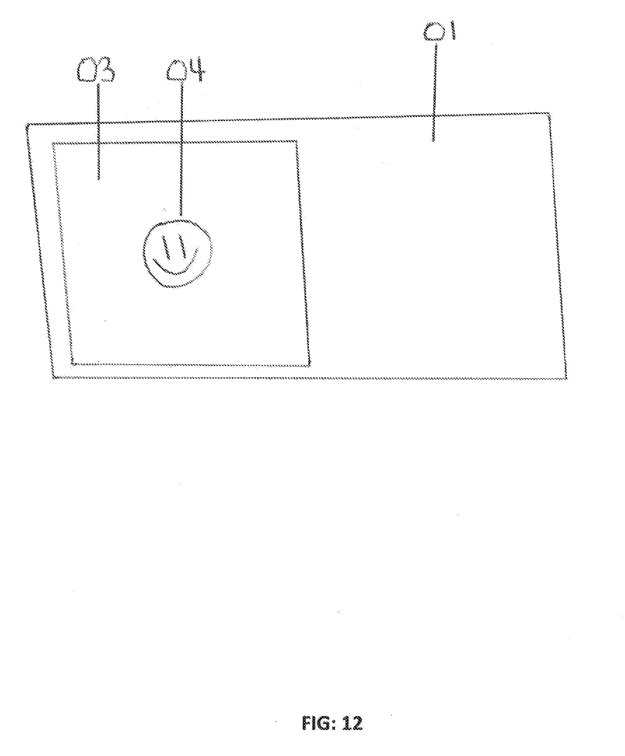

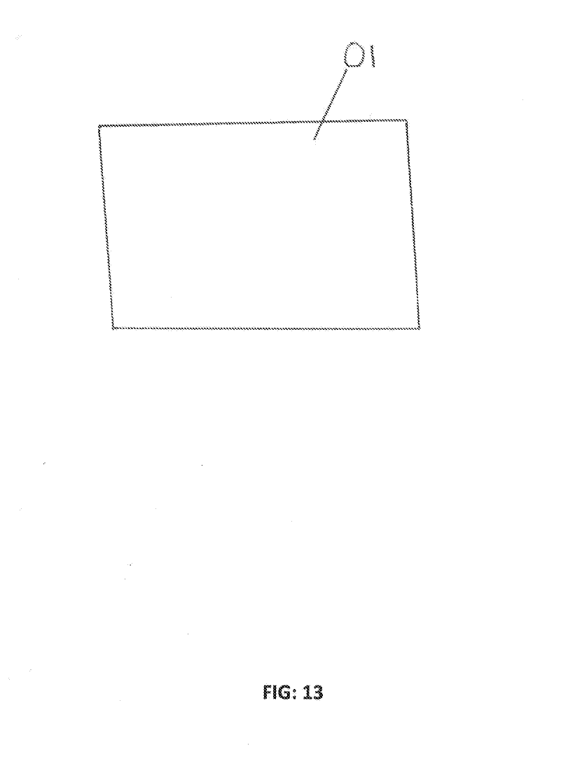

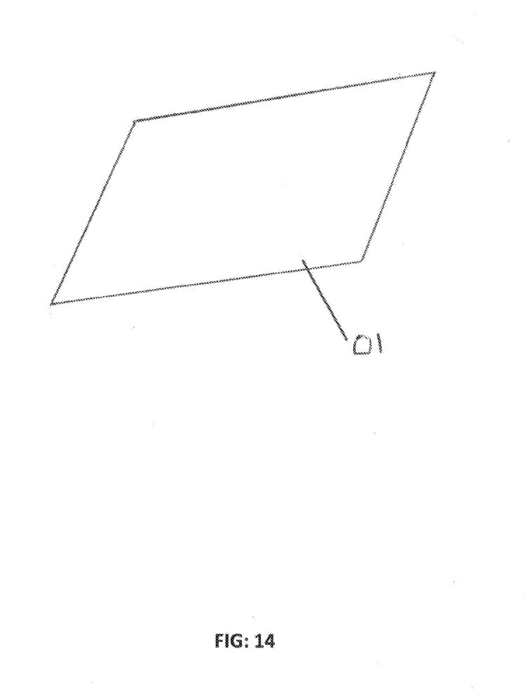

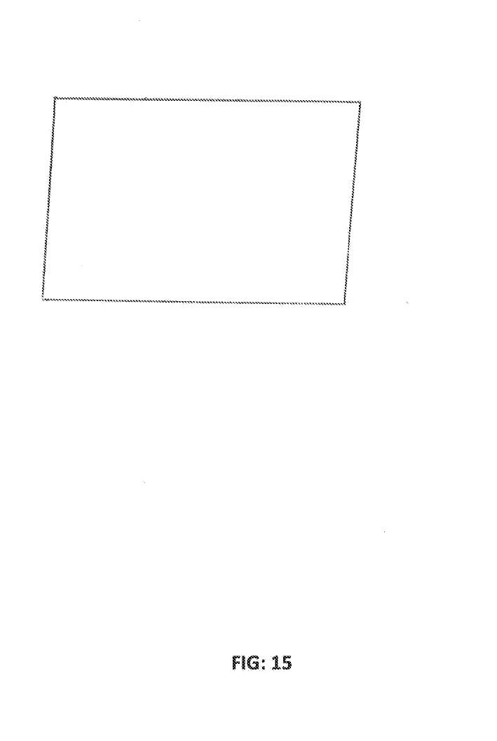

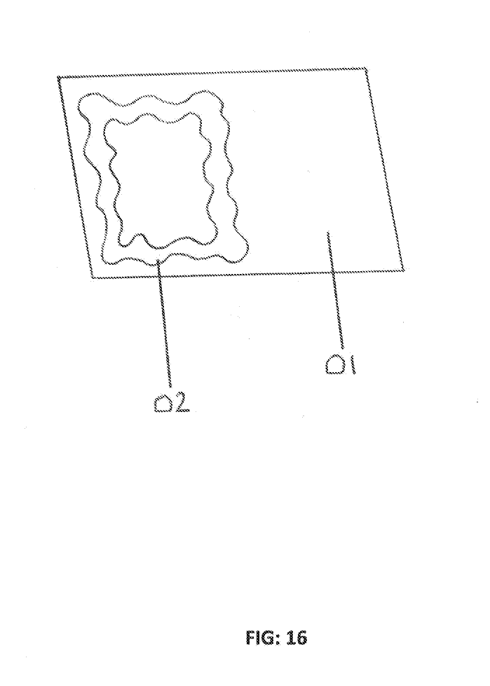

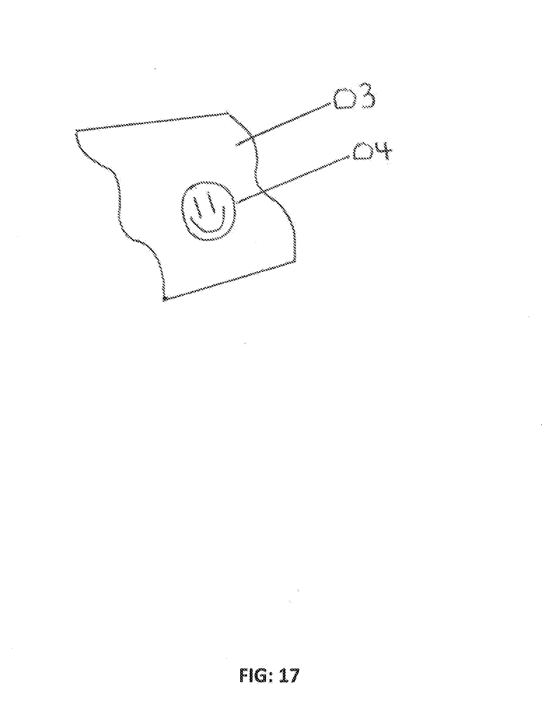

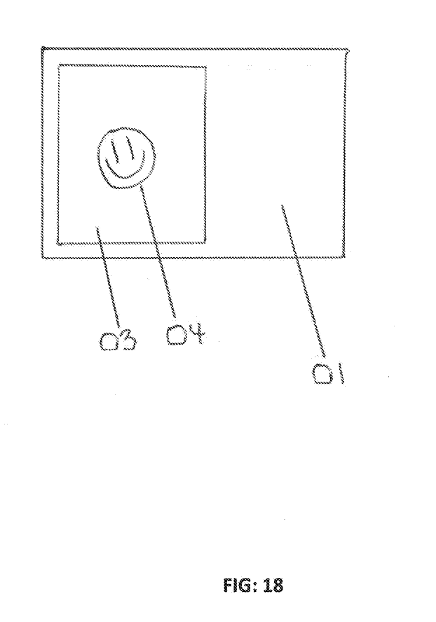

### FIG. 4 of 18

[01] Upper Front internal view of card in the form and dimension and measurement of a card of greeting

[02] Glue adhesive compound applied to card

### FIG. 5 of 18

[03] Highly flexible, highly reflective surface stock cut to measurement

[04] Sample reflected image therein

### FIG. 6 of 18

[01] Upper Front internal view of card in the form and dimension and measurement of a card of greeting

[03] Highly flexible, highly reflective surface stock cut to measurement applied to card by [02] Glue adhesive compound applied (NOT VISIBLE)

[04] Sample reflected image therein

### FIG. 7 of 18

[01] Upper Rear view of card in the form and dimension and measurement of a card that is postal

### FIG. 8 of 18

[01] Upper Front angled view of card in the form and dimension and measurement of a card that is postal

### FIG. 9 of 18

[01] Upper Front internal view of card in the form and dimension and measurement of a card that is postal

### FIG. 10 of 18

[01] Upper Front internal view of card in the form and dimension and measurement of a card that is postal

[02] Glue adhesive compound applied to card

### FIG. 11 of 18

[03] Highly flexible, highly reflective surface stock cut to measurement

[04] Sample reflected image therein

### FIG. 12 of 18

[01] Upper Front internal view of card in the form and dimension and measurement of a card that is postal

[02] Glue adhesive compound applied (NOT VISIBLE)

[03] Highly flexible, highly reflective surface stock cut to measurement applied by

[04] Sample reflected image therein

### FIG. 13 of 18

[01] Upper Rear view of card in the form and dimension and measurement of a card that is of business

### FIG. 14 of 18

[01] Upper Front side angled internal view of card in the form and dimension and measurement of a card that is of business

### FIG. 15 of 18

[01] Upper Front angled internal view of card in the form and dimension and measurement of a card that is of business

### FIG. 16 of 18

[01] Upper Front internal view of card in the form and dimension and measurement of a card that is of business

[02] Glue adhesive compound applied to card

### FIG. 17 of 18

[03] Highly flexible, highly reflective surface stock cut to measurement

[04] Sample reflected image therein

### FIG. 18 of 18

[01] Upper Front internal view of card in the form and dimension and measurement of a card that is of business

[03] Highly flexible, highly reflective surface stock cut to measurement [02] Glue adhesive compound applied (NOT VISIBLE)

[04] Sample reflected image therein

1. The See They' Self Card is any Card to include a Card that can become folded with the express intent of this Card being to convey a written or printed or affixed by any means message upon this Card to any end user. Prior Art Cards include Cards manufactured from any material to include paper, cardboard and any card stock, and plastics. Furthermore, uniquely herein the present invention is the hybridization of this present invention of a Card with a highly flexible, highly reflective surface stock, of such Prior Art is any Mirror.
The “See They' Self Card” present invention herein combines the industry of Cards in all forms designed to comport any message, any sentiment, or any data and the industry and the manufacture of highly flexible, highly reflective surfaces that result with the effect of permitting one to See their reflection simultaneously.

2. The “See They' Self Card” is new, unique and different from all prior art. The present invention is intended to present to the end user recipient with a pre-written message from an end user author or drafter to appear directly aside the installed highly flexible, highly reflective surface stock simultaneously. The present invention herein now provides the means of a hightened experience by means of written, drafted, or affixed communications fused as hybrid with a highly flexible, highly reflective surface resulting in a hightened interactive experience for each and all end-users. The actual measurements and dimensions of this present invention in all forms may and shall vary.

3. The “See They' Self Card” is otherwise a blank Card stock with an affixed to the Card, a highly flexible, highly reflective stock, and the resulting highly flexible highly reflective surface stock is not of Glass.
A utilitarian feature and factor of this present invention herein is that the resulting highly flexible highly reflective surface stock applied to the “See They' Self Card[s]” may and shall be of service to the end user/recipient as a means of providing a reflection (of themselves) at locations where glass and metals are prohibited.
An Example of “the See They' Self Card” as an item: The present invention herein is of Card stock manufactured from any material to include paper, cardboard, and any card stock, and plastics and a highly flexible, highly reflective surface that results with the effect and means in function whereby an end-user recipient may read the provided scripture and simultaneously See Themselves in the resulting reflection.
